(19) United States
(12) Patent Application Publication
(10) Pub. No.: US 2008/0133676 A1
(43) Pub. Date: Jun. 5, 2008

(54) Method and system for providing email

(76) Inventors: John Choisser, San Diego, CA (US); Charlie Recksieck, Encinitas, CA (US); Al Vistaunet, San Diego, CA (US)

Correspondence Address: NATH & ASSOCIATES, PLLC, 112 South West Street, Alexandria, VA, 22314, US

(21) Appl. No.: 11/607,095

(22) Filed: Dec. 1, 2006

(51) Int. Cl. G06F 15/16

(52) U.S. Cl. 709/206

(57) ABSTRACT

A method for providing an email from a user to a recipient includes: maintaining a first database of recipients including recipient identifiers and recipient email addresses and including an entry for the recipient; maintaining a second database of user descriptors not directly entered by the user; taking the email from the user, where the email is directed to at least one of the recipient identifiers; sending the email to the recipient; and sending at least one of the user descriptors to the recipient. The recipient email address is not revealed to the user.

### FIELD OF THE INVENTION

The present inventive subject matter relates to methods for providing email from a user to a recipient.

### BACKGROUND OF THE INVENTION

Various interfaces have been proposed to provide electronic mail, or “email,” from one individual or organization to another. These known interfaces leave much room for improvement.

Presently, it can be difficult and time-consuming to determine an individual's email address. Browsing the Internet searching for an email address can be time consuming and frustrating. Often an individual must be contacted by a different medium entirely (such as telephone) just to determine where to address his email. Individuals also must often tediously navigate a company's website in an effort to find a relevant contact email address, which often times is not even present on the website.

Further, at present, there is no established site or presence on the web for users to quickly find email addresses for businesses, public figures, or other people who users frequently would want to contact. Moreover, there is no established site or presence on the web for users to address one email to multiple recipients within a chosen category.

Existing email systems have been overrun with unsolicited email, advertisement email, and other junk email. Simply placing one's email address online is essentially an invitation for unwanted email, email containing obscenities, and email containing viruses. Even when a user can find an email address, given the state of spam and unsolicited emails, many emails are ignored by their recipients altogether. This is a detriment not only to an email author, but also to the recipient. On the receiving end, governments, businesses, celebrities, agents and others lose valuable lines of communication with the public.

Moreover, present email systems merely deliver the substantive content of an email from a user to a recipient. Recipients are poorly served when they are not provided with the great amounts of data that could be compiled before, during, or after preparation of an email, and sent to the recipient alongside the email. These data can include user descriptive information, which may or may not be entered by the user, and usage patterns based both on the email and on other email descriptors.

### SUMMARY OF THE INVENTIVE ASPECTS

The present inventive subject matter addresses the above issues in a novel way.

The present inventive subject matter relates to a method for providing an email from a user to a recipient. The method includes maintaining a first database of recipients including recipient identifiers and recipient email addresses, and including an entry for the recipient; maintaining a second database of user descriptors not directly entered by the user; taking the email from the user, wherein the email is directed to at least one of the recipient identifiers; sending the email to the recipient; and sending at least one of the user descriptors to the recipient. The recipient email address is not revealed to the user.

In some embodiments, the user is provided with an online interface displayable in a standard web browser.

In some embodiments, the user is provided with an online interface displayable via a PDA, mobile phone, or handheld computing device.

In some embodiments, at least one of the recipient identifiers is a categorical identifier applied to more than one recipient, and the email is directed to at least one categorical identifier. In some embodiments, these categorical identifiers include only recipients who have agreed to be identified by categorical identifiers.

In some embodiments, the method includes: maintaining a third database of email descriptors; calculating at least one usage pattern from the third database; and sending the usage pattern to the recipient.

In some embodiments, the method includes: maintaining a third database of email descriptors, and computing the likelihood based on said email descriptors that the email is a duplicate of a previously-sent email. If an email is determined to be a likely duplicate the recipient may be notified.

In some embodiments, the method includes: computing the likelihood that the user is an automaton.

In some embodiments, the method includes: analyzing the email to identify objectionable content.

In some embodiments, the method includes: maintaining a black-list database of unwanted network addresses, and identifying unwanted senders by comparing a user characteristic to the black-list database.

In some embodiments, the method includes: providing the recipient with a local email inbox, which receives only email which is drawn to at least one recipient identifier in the first database. The sending step sends the email to the local email inbox.

In some embodiments, the sending step sends the email to a recipient's email address.

In some embodiments, the method includes: providing the user with an interface for composing the email. The taking step accepts the email by way of the interface.

In some embodiments, the taking step takes the email by way of another email application.

In some embodiments, the method includes: providing the user with an interface for searching the first database.

In some embodiments, the method includes: providing the user with an interface for browsing the first database.

The present inventive subject matter also relates to an apparatus that provides an email from a user to a recipient. The apparatus includes: a first database of recipients including recipient identifiers and recipient email addresses; a second database of user descriptors not directly entered by the user; an email taker which takes an email from the user, wherein the email is directed to at least one recipient identifier; and an email sender which sends the email to the recipient and further sends at least one user descriptor to the recipient. The recipient email address is not revealed to the user.

In some embodiments, at least one of the recipient identifiers is a categorical identifier applied to more than one recipient, and the email is directed to at least one categorical identifier. In some embodiments, these categorical identifiers may include only recipients who have agreed to be identified by categorical identifiers.

In some embodiments, the apparatus includes a third database of email descriptors, and an analyzer that computes at least one usage pattern from the third database. The email sender sends the usage pattern to the recipient.

In some embodiments, the apparatus includes a third database of email descriptors, and an analyzer that computes the likelihood based on the email descriptors that the email is a duplicate of a previously-sent email.

In some embodiments, the apparatus includes an automaton analyzer that computes the likelihood that the user is an automaton.

In some embodiments, the apparatus includes an analyzer that computes if the email contains objectionable content

In some embodiments, the apparatus includes a local email inbox which receives only email drawn to the recipient's recipient identifier in the first database. The sender sends the email to the local email inbox.

In some embodiments, the sender sends the email to a recipient's email address.

In some embodiments, the apparatus includes an interface for composing the email. The taker accepts the email by way of the interface.

In some embodiments, the taker accepts the email by way of another email application.

In some embodiments, the apparatus includes an interface for searching the first database.

In some embodiments, the apparatus includes an interface for browsing the first database.

In some embodiments, the apparatus includes a black-list database of unwanted network addresses, and an analyzer that identifies unwanted senders by comparing a user characteristic to the black-list database.

The present inventive subject matter also relates to a system for sending an email from a user to a recipient. The system includes means for maintaining a first database of recipients including recipient identifiers and recipient email addresses, and including an entry for the recipient; means for maintaining a second database of user descriptors not directly entered by the user; means for taking the email from the user, wherein the email is directed to at least one of the recipient identifiers; means for sending the email to the recipient; and means for sending at least one of the user descriptors to the recipient. The recipient email address is not revealed to the user.

The present inventive subject matter also relates to a machine readable medium containing instructions for sending an email from a user to a recipient. The medium includes: instructions for maintaining a first database of recipients including recipient identifiers and recipient email addresses, and including an entry for the recipient; instructions for maintaining a second database of user descriptors not directly entered by the user; instructions for taking the email from the user, wherein the email is directed to at least one of the recipient identifiers; instructions for sending the email to the recipient; and instructions for sending at least one of the user descriptors to the recipient. The recipient email address is not revealed to the user.

### BRIEF DESCRIPTION OF THE FIGURES

In the detailed description of the invention presented below, reference is made to the accompanying drawings in which:

FIG. 1 charts a method for providing an email from a user to a recipient.

FIG. 2 shows an arrangement for an apparatus for providing an email from a user to a recipient.

FIG. 3 shows an example of a system for providing an email from a user to a recipient.

### DETAILED DESCRIPTION OF THE INVENTION

In the following detailed description, reference is made to the accompanying drawings, which form a part hereof, and in which is shown by way of illustration specific embodiments in which the invention may be practiced. In this regard, terminology such as “first,” “then,” “afterwards,” “before,” “next,” “finally,” etc., is used with reference to the drawing being described. Because the processes and methods of the present invention can be performed in a number of different orders, the above terminology is used for purposes of illustration and is in no way limiting. It is to be understood that other embodiments may be utilized and logical changes may be made without departing from the scope of the present invention. The following detailed description, therefore, is not to be taken in a limiting sense, and the scope of the present invention is defined by the appended claims.

In the following description of the disclosed method, apparatus, and system, the following terms will be used consistently: “user” refers to the source of an email (non-limiting examples: an individual, a collective entity, a machine, or a computer process); “recipient” refers to the intended receiver of an email (non-limiting examples: an individual, a collective entity, a machine, or a computer process); “email address” refers to the address which routes communications to the recipient (non-limiting examples: a Simple Mail Transfer Protocol (SMTP) address, a Fully Qualified Domain Address (FQDA), an Internet Message Access Protocol (IMAP) address, or an intranet address); “CAPTCHA,” stands for “Completely Automated Public Turing test to tell Computers and Humans Apart” and refers to any number of such methods for telling the difference between a human user and a automaton.

It will be clear to one skilled in the art that the following method and apparatus may be implemented in many ways. As non-limiting examples, the databases may be maintained on one or more servers which can communicate with each other or with a central control processor by TCP/IP or another known network protocol. The same or a different network protocol may also be used for communication between the central control processor and the user, or with another server and the user. Alternately, the databases may be maintained on a single system (for example, in an intranet environment), where the system also interacts directly with the users. Interfaces may be provided in HTML over the HTTP protocol, in PHP pages, in XML format, in JAVA formats, or in any other appropriate format.

Most of the method disclosed below may be performed in a typical LAMP (Linux-Apache-MySQL-PHP) set-up, although MySQL may be changed to Oracle or an equivalent database format. ADO (Active Data Object) or MySql technology may be used as the method for having the PHP files read the databases.

The “maintenance” of databases can refer to manual updates by human operators; automatic updates based on RSS feeds, web crawlers, or other data sources; semi-automatic updates based on released public information; and pass-through lookups, which take user-input information and pass the information to a third-party lookup service, and then provide results of the third-party lookup to the user in a format for viewing and selection. Parties may be given the option to request inclusion in the recipient database and to choose an identifier. Data can be maintained in other ways known to those skilled in the art, and these are only examples.

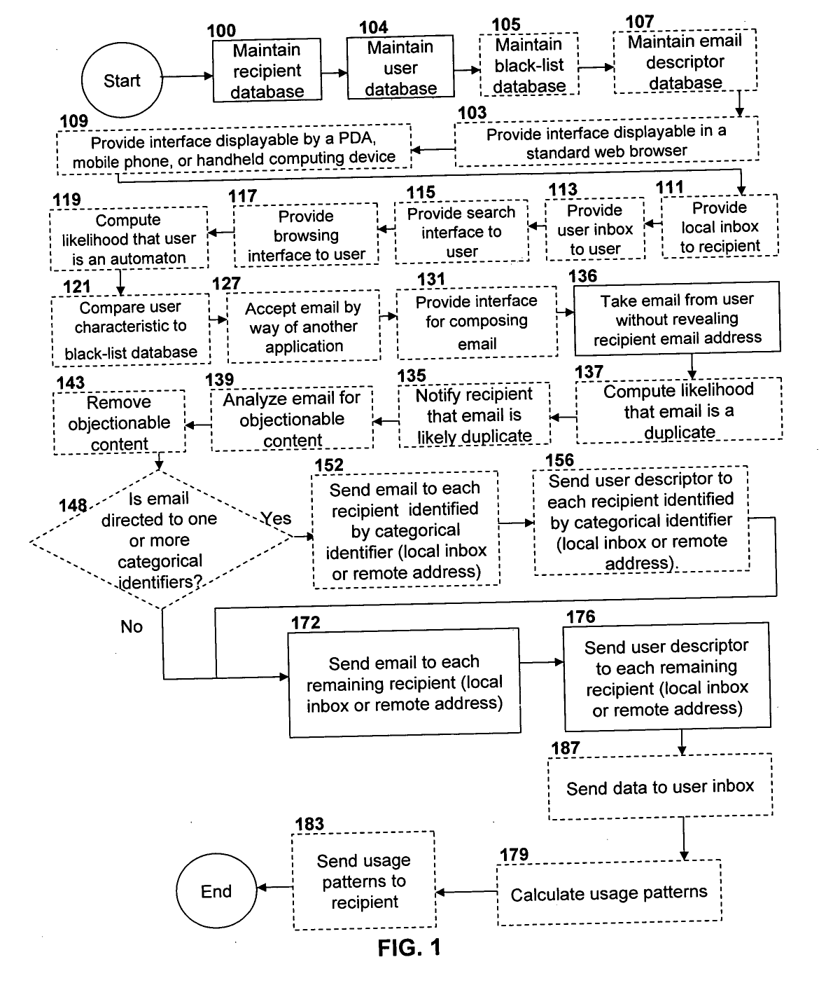

FIG. 1 charts a method for providing an email from a user to a recipient. In FIG. 1, elements and connections which are not found in all disclosed embodiments are indicated with dashed lines. Importantly, the original user does not need to know how to directly reach the recipient when the process begins. The method includes maintaining a recipient database (step 100). The steps of maintaining this and other databases may, as a non-limiting example, include acts such as accessing database records, updating database records, adding new database records, removing database records, compressing database records, or taking the necessary steps to keep the database accessible. The databases could be maintained on one apparatus (such as a hard drive, optical drive, microprocessor, server, or internet site) or across multiple apparatuses. Maintenance may be performed by one or more agents.

To minimize any down time, it may be essential to keep these databases available to the user at all times. Accordingly, instead of modifying a copy of the database on an administrator's local machine then “uploading” the database, there may be provided maintenance pages online, and/or an interface build to allow personnel to upload batches of new recipient records. This functionality may also allow personnel to edit or delete items already in the database “live” via a webpage or other interface with (secure) login and/or an executable program to be run on a local machine. Maintenance functions provided in a local executable may be able to leverage more robust coding options as opposed to an application for maintenance to be done while in a web browser. As a non-limiting example, a Maintenance Tool can be provided to personnel to add, edit and delete records in the databases (such as recipient records), to upload batches of new listings, and to perform a number of other maintenance functions.

In may cases, the databases should be able to function well in a high-traffic, multi-user environment. Known databases of this kind include, but are not limited to, Oracle, Interbase and high-performance SQL Server databases. Maintenance of the database may also include the scheduling and/or execution of frequent and redundant database backups. PHP, HTML, and other web files may also be stored on separate primary and secondary web servers to ensure as close to 100% up-time as is possible. A maintenance interface may automatically put the latest maintenance changes on both servers and the designated backup area, or these changes may be made manually.

The recipient database is provided with at least recipient identifiers and recipient addresses. The recipient database may also include entries for recipient categories, keywords for searching among categories or recipients, and/or additional fields of recipient data not directly utilized by the user. The recipient identifiers refer to one or more underlying recipients. Non-limiting examples of recipient identifiers include full names, surnames, and employer-title pairs (for example, “President—First Federal Bank” or “Chief Surgeon—Georgetown University Medical Center.”) Other non-limiting examples of recipient identifiers can include employers, titles, geographic locations, families, and services provided. One recipient identifier may refer to more than one recipient (for example, “First Federal Bank” may be a “categorical identifier” which refers to select employees of First Federal Bank, or even to every employee of First Federal Bank). Also, one recipient may be represented by multiple recipient identifiers (for example, the recipient referenced by “President—First Federal Bank” may also be referenced by “President—Rotary Club—Hoboken, N.J.” or even “Joe Smith—Hoboken, N.J.). While these may be recipient identifiers visible to a user, additional invisible recipient identifiers may be used to represent one or more recipients in the disclosed method.

Non-limiting examples of categories of recipients which may be present in the recipient database (as categorical identifiers or as individual recipient identifiers) include: hotel chains, airlines, restaurant chains, retail entities, car rental agencies, state and federal politicians and political organizations, celebrities, state and local government offices, newspapers, magazines, television networks, sports teams, telephone companies, and service providers.

Several categories of recipient may allow for multiple contact information listings within that company or entity. For instance, universities may have multiple listings (e.g. “admissions”, “administration”, etc.). Such recipients will have multiple records in the recipient database, with the specific department and recipient email addresses being distinct in each record.

The method includes taking an email from a user (step 136). The user may directly provide an email accompanied by a known recipient identifier. Optionally, a search interface may be provided to the user (step 115). The user may use this search interface to enter one or more search terms into the search interface, and the interface will present a list of recipient identifiers which best match the search term(s) by name or by description. The search functionality may search one or more fields in the database, such as company name, contact name, department, recipient category and keywords. A search algorithm can score or rate the likelihood of a match based on the quality of the match, with certain database fields being given higher priority. The user may, as a non-limiting example, see search results displayed in descending order of “search score” out of 100.

Optionally, a browsing interface may be provided to the user (step 117). The user may use this browsing interface to browse through a hierarchical list of recipient identifiers and categories to select a recipient for his email. The entries in this browsing interface may be assembled and organized in many different ways, as set forth above in discussing maintenance of the databases. In some scenarios, users may be allowed to select multiple recipients as the recipient(s) of the email.

Importantly, while the above interfaces present select recipient identifiers to the user such as company name and department, they do not present a recipient's email address. Various advantages are achieved by keeping the email address hidden from the user. Such advantages may include protection of a sensitive email address from web spiders and other search agents which compile lists of email addresses for unsolicited mail delivery.

Regarding the search, browsing, and other interfaces: if these and other interfaces are provided over the Internet, they may be written using PHP code, as it may be desirable for the interfaces may contain a wealth of dynamically-created content. For instance, certain records in the database may indicate that additional fields are to be available to the user as he enters his email. As a non-limiting example, if the user selects an airline's customer service department as a recipient, its record in the database may contain a value telling the PHP code that there should be a box to gather a Flight Number from the sender. In this way, the email-entry interface can be dynamically modifiable (in this example, to display a required flight-number field), and manner where the dynamic content can be search engine optimized so that browsers in popular search engines may find the object of their searches on the proposed PHP page for a particular recipient contact, thereby drawing more users to a provider of the method disclosed herein. The pages may contain displayable fields which are based on stored preferences for the selected recipient or for a class of recipients.

In the browsing interface, the hierarchy and structure of the database in the category fields may form the structure and links for the browsing directory. In contrast, in the search interface a search function may search relevant fields in the recipient database (company, department, categories, keywords) and display only a list of relevant found recipients. In either interface, once one or more recipients are selected, a mail interface may then be presented with information populated by items for the particular recipient, according to its record in the database. Such database records may include information on which fields will be available for completion to be sent to the selected recipient(s).

While the code and content may be written in PHP pages, the formatting, font, size and other design elements may be encoded in a Cascading Style Sheet (.CSS) so that changes to the look of the displayed text will be easily accomplished in one location. There may be a second or third CSS page dictating the look of particular pages. If there is to be a variety of styles and large amount of information pertaining to element styles, several of the document classes can be maintained in separate CSS sheets, so as to make sure the file size and page loading speed for each page is reasonable.

The disclosed method may include certain optional mail handling features. As non-limiting examples, the disclosed method may include computing the likelihood that the user is an automaton (step 119) through (as a non-limiting example) the required retyping of a few non-machine-readable characters presented to the user, or other CAPTCHA techniques. This step may occur before or after submission of email content. The disclosed method may further include analyzing the email for objectionable content (step 139) such as (non-limiting examples) pornographic images or vulgarities. The method could include removing objectionable content (step 143) or simply rejecting the message outright.

The method may include the step of maintaining a black-list database (step 105) A user characteristic such as a sender's IP address can be checked against lists of black-listed IP addresses (as a non-limiting example, those of known spammers) (step 121). Recent problem IP addresses can be stored in the black-list database on a regular basis, updated as needed, and made available during the composition or delivery of an email. IP address is only one identifier by which a user may be blacklisted; others may include: country of origin (for recipients who only want to receive mail from one geographical area), selected user name, telephone number, or any other identifier by which an undesirable user can be filtered out. Problem IP addresses may also be provided by a third-party service.

The method may include the maintenance of an email descriptor database (step 107) where descriptive information is kept about some or all of the email provided by the disclosed method. This descriptive information may be formed from previously sent emails through the website. This descriptive information (or “email descriptors”) may be used, for example, in computing the likelihood that an email is a duplicate (step 137) of a previous email sent to the same recipient (of which the user can be notified, step 135), or of an email sent to multiple recipients (and thus potentially SPAM). These email descriptors may include textual elements of the messages sent. The stored email descriptors can be maintained in the same database as the recipient information, the user descriptors, the black-list entries, or can be in its own database. The stored email descriptors can be stored in a database that can easily be joined in a query of the recipient database. As a non-limiting example of email descriptor storage, each email's contents and its sender information may be stored in a database of sent emails; older messages may be purged to keep the database a maintainable size; chunks of the message may be available for comparison to previous messages and if redundant, then appropriate action may be taken—i.e. reporting this to the recipient, rejecting the message, compressing the stored message appropriately, or other scenarios.

These optional advantageous mail-handling features (such as obscenity filters, duplicate email filters, spam filters, virus filters, and more) may lead a recipient to prefer that his email be delivered only by the preferred method. To his end, he may choose never to publish his ultimate email address, and instead publish only a recipient identifier by which he may be reached through the presently disclosed method (which, as discussed above, also never discloses his email address). The presently disclosed method would then effectively become the only channel by which his ultimate email address may be reached. Alternately, the presently disclosed method may optionally include a step of providing the recipient with a local email inbox (step 111). The local email inbox could be stored on an email server maintained by an operator of the presently disclosed method. The local email inbox provided to the recipient may be configured to only accept email from a limited number of sources, or may only accept email entered through the method disclosed herein. The local email inbox may be provided to the recipient as an additional benefit. The local email inbox would be stored on an email server maintained by an operator of the presently disclosed method. In this manner, recipients could separately check their email received via the method disclosed herein. The email taker could check if the recipient database has a local address recorded for a selected recipient; if so, the sender then directs the message to this local address, and not to any outside mail server.

A user (i.e., one who is sending an email) may also be provided a user inbox (step 113) as an additional benefit. The user inbox would also be stored on an email server maintained by an operator of the presently disclosed method. In this manner, data such as carbon copies of emails, or data identifying the rejection of a submitted email, can be provided to the user (step 187). As non-limiting examples, a user inbox may allow a user to receive feedback from a mail server without providing an external email address, or may allow a user to track receipt of his message.

Optionally, the disclosed method may include the step of providing a user with a web interface for sending email (step 131). This web interface may be as few as one simple field for entering content, or may include multiple fields for expected entries such as the user's name or return email address, or the dynamically-added fields indicated in the recipient database as described above. While the interface may allow for advanced email editing and content (such as page formatting, underlining, and other text modifications), it may be advantageous to restrict the input to simple text content, thereby protecting the recipient from harmful HTML tags, which can carry dangerous code or may carry images with inappropriate or undesired text. Accordingly, the interface may limit the user to text-entry only, or may screen uploaded messages to remove all by the text content.

This web interface may be made available to any public user, or may be provided only to users who sign in with a local account. This web interface may be integrated with the optional search interface set forth above.

Alternately, or in tandem with the web interface set forth above, the disclosed method includes the optional step of accepting an email by way of another application. (step 127). This option may be provided as a premium or paid product, and may be a software interface which the user runs on his computer, together with or independent of his web browser, which allows for entering email content. The software interface may gather information on the user for inclusion with the email, with or without the user's knowledge. Alternately, the software interface may be a passive interface which directs email from a known email client (such as Microsoft Outlook, a registered trademark of Microsoft) to a server or other provider of the disclosed method. Also, the method can directly acquire email from a known email client such as Yahoo! mail.

Users may be provided with the ability to send one message to a multitude of recipients; as a non-limiting example, a sender interested in getting a book published may want to send a query to multiple publishers. To differentiate such a mass emailing from SPAM, the multiple-recipient feature may be offered only as a premium service, and/or may only be possible for recipients who opt-in and deliberately allow themselves to be part of a group recipient list.

Any of the searching, browsing, email forming, or feedback delivery interfaces disclosed herein may be provided in a form displayable by a standard web browser (step 103). A “standard web browser” may refer to, but is not limited to, any program or apparatus capable of displaying html or other pages provided on the world wide web. Alternately, any of the above interfaces may be provided in a form displayable by a PDA, mobile phone, or handheld computing device (step 109) to senders who wish to send emails according to the method disclosed herein from their Personal Digital Assistant (PDA), cellular phone (or “cell phone”), or other handheld computing devices. The handheld computing devices may include, but are not limited to: tablet PCs, mini PCs, portable chat or video game systems, messaging-enabled wireless devices, airplane or vehicle computer terminals, and/or any other device capable of displaying web pages. These interfaces may have their own simplified formatting within the PHP or other pages, adapted for the limited size of displays for mobile senders. The mechanics and code may be substantially the same as the normal, full online PHP or web pages, and both types of interfaces may interact with the recipient database in the same way. The provided mobile interface may be a stripped down “nuts and bolts” display for mobile users, or may be a full fledged interface adapted to fit a smaller screen.

For efficiency, reusable code may be shared between the standard interface(s) and the mobile interface(s), but as bandwidth is more of an issue for mobile users, file size and image use may be minimized in the mobile interface. Maintenance may be performed on either interface in a similar manner.

As a non-limiting example, the PHP file which is the target of the email form, after going through the analytical processes, may output various fields as an email to the recipient whose ID is still in memory; it would be at this time that an email address will be looked up in the recipient directory. Additional fields for a particular recipient or category of recipient may be listed as text within the message body sent to the recipient. The email will be sent as the results of the final Analyzer PHP page with the it's fields formatted as a standard email with a mail to:<recipient email address> as the action for the PHP-processed output.

When taking an email from a user (step 136) the disclosed method includes the step of determining if the email is addressed to one or more categorical identifiers (step 148). If so, the email is sent to each recipient identified by each categorical identifier (step 152). The email is also sent to each recipient directly identified by a (non-categorical) recipient identifier (step 172).

In addition, a user database may be maintained (step 104). The user database contains entries for some or all users of the system, wherein each entry may contain one or more user descriptors. The user may log in to the system before or after preparing an email for sending, thereby associating the author of the email with one or more of these user descriptors. Alternately, the database may temporarily store user information in a temporary account for part or all of one or more sessions for a user without requiring a log-in account. Even users with a log-in account may have descriptors which are temporarily stored for the duration of their session or for a few sessions, but which are not permanently kept in the user descriptor database.

While some of these user descriptors may be directly entered by the user upon setting up the account (as a non-limiting example, the user's name), other descriptors may be created, stored, modified, or updated without user input. Non-limiting examples of such input-free descriptors include: the average duration of the user's email session; the user's IP address, the user's geographic location as determined by the network address; the number of emails sent by the user in the past session or in the past year; the user's operating system and browser, or patterns of user behavior during repeated use of the method disclosed herein.

In the disclosed method, these user descriptors are sent to one or more email recipients (steps 156 and 176). These user descriptors may be sent around the time that the message is sent, or may be sent at an earlier or later time (as a non-limiting example, at the time they are compiled). All descriptors may be sent to all recipients, or different descriptors can be sent to different recipients. As a non-limiting example, recipients who subscribe to a service that provides the disclosed method may be sent one or more useful user descriptors, while recipients who do not subscribe to the service provider, or who pay less for the service, may be sent no user descriptors. Different recipients can be sent different descriptors, and a recipient can tailor which descriptors, or classes of descriptors, he receives. Descriptors may also be automatically included when a message is sent by way of a categorical identifier, so that the recipient knows if he was contacted as an individual entity or as a member of a categorical listing.

The delivery of some user descriptors may be provided as a premium or paid service.

User descriptors can also be used to prevent repeat messages being sent to the same recipient. The associating of identifying message information with a user can also be a valuable second technology in preventing spam; if a message is sent from one sender to several users, a repeat message sent to a new, different recipient will be examined more closely for its potential as a spam message. Similarly, this information can be provided to the recipient as a warning, when the message is potentially but not identifiably spam.

It is emphasized that the maintenance of the databases (steps 100, 104, 105, 107) may take place at any time during the disclosed method. As a non-limiting example, the user database need not be maintained only at the beginning of the method, but may be updated with information during the preparation of an email, or immediately after a user sends the email, or upon recognition that a reply has been made to the email. Similarly, the email descriptor database may be updated upon sending of an email (as a non-limiting example, to reflect a new tally of emails sent containing certain words, or sent at a certain time). Maintenance steps may be performed locally through a maintenance tool. Accordingly, the timing of changes to the database could conceivably generate coincidental errors during the search, browse or send functions if related data is changed. Errors generated should be identifiable and messages could be returned to the sender in readily-understandable language (for example, by an error handler). Based on the error returned, posted attempts at searches or sending of email can in some cases be resubmitted automatically. A database of error codes, messages for users and procedures to be executed can be maintained in such an error handler.

The disclosed method optionally includes the steps of calculating usage patterns (step 179) and sending these usage patterns to the recipient (step 183). Again, these usage patterns may be sent around the time that the email is sent to the recipient, or may be sent at an earlier or a later time. As non-limiting examples, these usage patterns may include information on how many emails are being sent to a given class of recipient, or on how many emails have been prepared and sent to the recipient or to another recipient, or on which other recipients were searched for by the user before preparing the email for the chosen recipient.

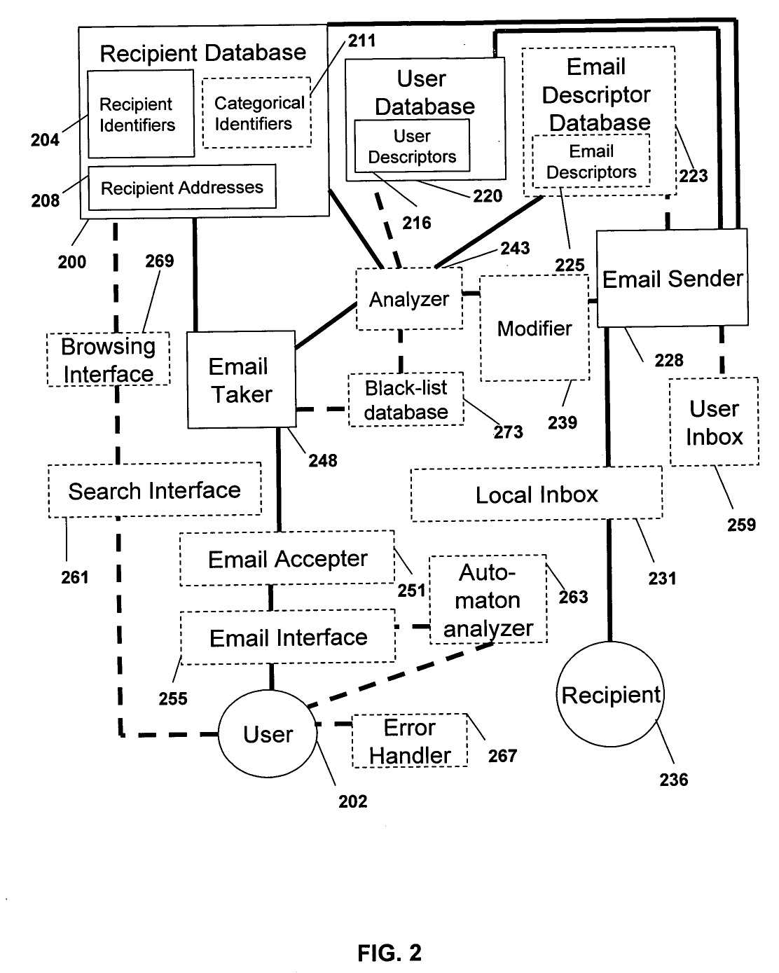

FIG. 2 illustrates a computing environment in which aspects of the invention are implemented. The disclosed environment includes a number of elements which may exist as physical entities (such as dedicated microprocessors or chipsets hardwired with relevant instructions), and/or other elements which may exist as instructions within a computer program. Some elements (such as the recipient identifiers 204) may exist as data on a server, which is read by a computer and used to perform functions as set forth in detail below. It should be understood that multiple elements of the disclosed environment may exist in one program, or be housed on one server, and may alternately involve more than one program or exist on more than one server. Although tasks of the method above and apparatus below have been separated for clarity, a given element of the apparatus below may perform one or more steps of the above method, and one or more steps may occur at the same time.

In FIG. 2, elements and connections which are not found in all disclosed embodiments are indicated with dashed lines.

In FIG. 2, a user (202) sends an email to a recipient (236). The user (202) determines one or more recipients for his email by interacting with a first database, or “recipient database” (200), which may be provided with a search interface (261), a browsing interface (269) which may include a hierarchical structure of recipients, or any other sort of interface with which user (202) may select one or more recipient identifiers (204). The recipient identifiers may be categorical identifiers (211). A recipient identifier (204) is associated with one or more recipient addresses (208), but as discussed above these are normally not disclosed to the user (202). The recipient address (208) may be the recipient's remote email address. Alternately, the recipient address may represent a local inbox (231).

The apparatus includes an email taker (248) and an email sender (228). These may include servers, processors, or programs and operating instructions disposed at the servers or processors. The email taker (248) and the email sender (228) may be disposed at the same machine or at different machines. The email taker (248) or email sender (228) may also be used to provide the interface (for example, search interface (261) or a hierarchical interface) by which the user (202) interacts with the recipient database (200) to select one or more recipients by way of their recipient identifiers (204), or this interface may be provided by another machine. Of course, the user (202) may also provide a recipient identifier (204) directly.

The email taker (248) or email sender (228) may also provide the email interface (255) by which the user (202) prepares an email, or this email interface (255) may be provided by another server or machine. This email interface (255) may be a web-based email creation portal, or may be software installed on a local user's machine, which then submits the email to the email taker (248). In addition, the user (202) may use third-party software to prepare the email, which is then sent to an email accepter (251), and ultimately to the email taker (248).

The email taker (248) may be in communication with a black-list database (273) in which the sender's IP address can be checked against lists of black-listed IP addresses (as a non-limiting example, those of known spammers). Recent problem IP addresses can be stored in the black-list database on a regular basis, updated as needed, and made available during the composition or delivery of an email. IP address is only one identifier by which a user may be blacklisted; others may include: country of origin (for recipients who only want to receive mail from one geographical area), selected user name, telephone number, or any other identifier by which an undesirable user can be filtered out. Recipients can optionally prepare their own black-lists.

Once received, the email may be subjected to one or more analyses by an analyzer (243) and a modifier (239). These analyses may be based on information within the email message, and/or within the recipient database 200, the user database 220, the email descriptor database 223, the black-list database 273, or any number of optional additional databases. The message may be analyzed to ensure that the message does not contain HTML code or other code which could cause harm to the recipient's computer. Analysis may also include (as non-limiting examples) analyzing the email for objectionable content and optionally removing what objectionable content is found by way of the modifier (239) or simply rejecting the message outright; or computing the likelihood that an email is a duplicate of a previous email sent to the same recipient, or of an email sent to multiple recipients. (and thus potentially SPAM).

The analyzer (243) may also, with or without the use of the email descriptor database (223), compute a usage pattern for sending to the recipient, compute the likelihood that the user is an automaton (although this may also be performed by the automaton analyzer (263), or compute if the email contains objectionable content and have the modifier (239) remove the objectionable content. Rules for determining objectionable content can be stored in an objection database (with the above databases or stored separately), which may be maintained via functions in a maintenance program or by any of the maintenance methods disclosed herein.

As a non-limiting example, the analyzer may compare chunks of the current message and sender identifiers against the email descriptor database or other database to discover trends, and if the selected recipient has a “Trend” field with a value of “True,” the trend or relevant info can be sent to the recipient.

These optional advantageous mail handling features (such as obscenity filters, duplicate email filters, spam filters, virus filters, and more) may lead a recipient to never publish his ultimate email address, and instead publish only the recipient identifier (204) by which he may be reached through the presently disclosed apparatus (which, as discussed above, also does not discloses his email address). Alternately, the presently disclosed system may optionally include a local inbox (231) for email. The local inbox (231) provided to the recipient may only accept email from a limited number of sources, or may only accept email entered through the method disclosed herein.

Analyses may also include, as a non-limiting example, computing the likelihood that the user is an automaton through (for example) the presentation and required retyping of a few non-machine-readable characters by an automaton analyzer (263). The email interface, or an independent interface, may display the characters needed to be entered as one of the fields on the form. Latest CAPTCHA technology could verify the correct entry of the code. Users may be given an opportunity to hear an audio version of the code needed to be typed, providing a viable option for legitimate sight-impaired or color-blind users. To outwit the steadily improving methods from spammers to defeat CAPTCHA technology, images may focus on segmentation methods, where letters are split into different colored segments with different colored backgrounds. Others methods may be used to attempt to combat the technique of a spammer, bot or site using unwitting live humans to decipher the code. The above black-listing, repeat message, and IP address identification technologies may be combined to keep unwanted messages from being delivered. It should be noted that this automaton analysis may take place before any other analysis is performed on message content.

Once an email has been received by the email taker (248), and optionally analyzed and modified by the analyzer (243) and modifier (239), the email is given to the email sender (228), which prepares for sending the email to the recipient (236). The email sender (228) determines if the email is addresses to one or more categorical identifiers (211). If so, the email is sent to each recipient identified by the categorical identifier (211). The email is also sent to each recipient directly identified by a (non-categorical) recipient identifier (204).

The email sender (228) may be in communication not only with the recipient database (200), but also with a second database, or “user database” (220), and even a third database, or “email descriptor database” (223). As discussed above, the user database contains entries for some or all users of the system. The user (202) may log in to the system before or after preparing an email for sending, thereby associating the author of the email with one or more user descriptors (216). Alternately, the database may temporarily store user information in a temporary account for part or all of one or more sessions for a user without requiring a log-in account. Even users with a log-in account may have user descriptors (216) which are temporarily stored for the duration of their session or for a few sessions, but which are not permanently kept in the user database (220).

Again, while some of these user descriptors (216) may be directly entered by the user (202) upon setting up the account (as a non-limiting example, the user's name), other user descriptors (216) may be created, stored, modified, or updated without user input. Non-limiting examples of such descriptors include: the average duration of the user's email session; the user's geographic location as determined by his network (or “IP”) address; the number of emails sent by the user in the past session or in the past year; or the user's operating system and browser.

In the disclosed apparatus, these user descriptors are sent to one or more email recipients (236) by the email sender (228). These user descriptors (216) may be sent around the time that the message is sent, or may be sent at an earlier or later time (as a non-limiting example, at the time they are compiled). All user descriptors (216) may be sent to all recipients, or different user descriptors (216) can be sent to different recipients. As a non-limiting example, recipients who receive email by way of the disclosed apparatus may be sent one or more useful user descriptors (216). Different recipients can be sent different user descriptors (216), and a recipient can tailor which descriptors, or classes of descriptors, he receives. User descriptors (216) may also be automatically included when a message is sent by way of a categorical identifier (211), such that the recipient knows if he was contacted as an individual entity or as a member of a categorical listing.

The email sender (228) may optionally calculate usage patterns and sending these usage patterns to the recipient (236). Again, these usage patterns may be sent around the time that the email is sent to the recipient (236), or may be sent at an earlier or a later time. These usage patterns may be compiled from email descriptors (225), user descriptors (216), and the content of the email.

The user may also be provided a user inbox (259) as an additional benefit. The user inbox may, as a non-limiting example, be provided by an email server which also provides the local inboxes (231). In this manner, data such as carbon copies of emails, or data identifying the rejection of a submitted email, can be provided to the user.

If at any point an error occurs, an error handler (267) may be in place to look up the error code (for example, a server error code) and translate that error code into a sensible message which is provided back to the user. The error handler may be in communication with any of the modules set forth above, such that (as non-limiting examples) an error initiating at the accepter, the taker, the analyzer, or during any database query, may be disclosed to the user in understandable terms, and/or may be recorded for later analysis.

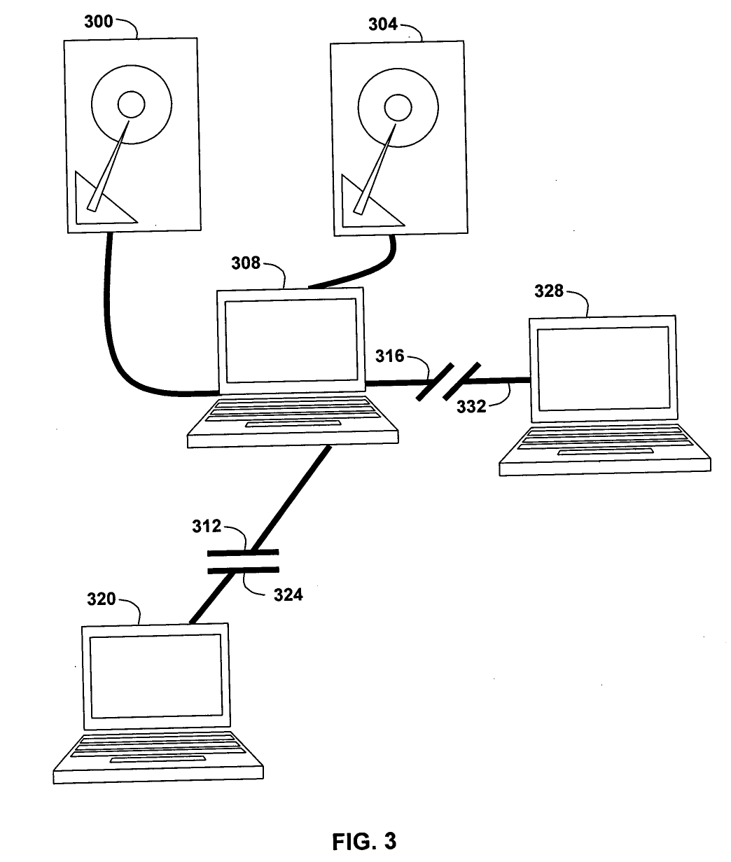

FIG. 3 shows an example of a system for providing an email from a user to a recipient. The system includes means for maintaining a first database of recipients (shown here in a non-limiting example as a hard drive (300) connected to a computer (308) running a program for database maintenance). The system also includes means for maintaining a second database of user descriptors (shown here in a non-limiting example as a hard drive (304) connected to a computer (308) running a program for database maintenance). The system also includes means for taking an email from a user (shown here in a non-limiting example as a network link (312) connecting the computer (308) to the user's computer (320), which also has a network link (324)). The system also includes means for sending the email to the recipient (shown here in a non-limiting example as a network link (316) connecting the computer (308) to the recipient's computer (328), which also has a network link (332)). The system also includes means for sending user descriptors to the recipient (shown here in a non-limiting example as a network link (316) connecting the computer (308) to the recipient's computer (328), which also has a network link (332)).

It should be noted, however, that this is only one physical example of means for performing the claimed functions, and that the claimed functions may easily be performed by a single processor running a computer program, stored on a machine readable medium, containing instructions for performing these steps.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

Having described the invention in detail and by reference to the embodiments thereof, it will be apparent that modifications and variations are possible, including the addition of elements or the rearrangement or combination or one or more elements, without departing from the scope of the invention which is defined in the appended claims.

What is claimed is:

1. A method for providing an email from a user to a recipient, the method comprising:
maintaining a first database of recipients including recipient identifiers and recipient email addresses, said first database including an entry for the recipient;
maintaining a second database of user descriptors not directly entered by the user;
taking the email from the user, wherein the email is directed to at least one of said recipient identifiers;
sending the email to the recipient; and
sending at least one of said user descriptors to the recipient;
wherein no recipient email address is revealed to the user.

2. The method of claim 1, wherein said taking step comprises:
providing the user with at least one interface displayable in a standard web browser.

3. The method of claim 1, wherein said taking step comprises:
providing the user with at least one interface displayable via a PDA, mobile phone, or handheld computing device.

4. The method of claim 1, wherein
at least one of said recipient identifiers is a categorical identifier applied to more than one recipient, and
the email is directed to at least one categorical identifier.

5. The method of claim 4, wherein said categorical identifier includes only recipients who have agreed to be identified by categorical identifier.

6. The method of claim 1, the method further comprising:
maintaining a third database of email descriptors;
calculating at least one usage pattern from said third database; and
sending said at least one usage pattern to the recipient.

7. The method of claim 1, the method further comprising:
maintaining a third database of email descriptors, and
computing the likelihood based on said email descriptors that the email is a duplicate of a previously-sent email.

8. The method of claim 7, the method further comprising
notifying the recipient when the email is determined to be a likely duplicate of a previously-sent email.

9. The method of claim 1, the method further comprising:
computing the likelihood that the user is an automaton.

10. The method of claim 1, the method further comprising:
analyzing the email to identify objectionable content.

11. The method of claim 1, the method further comprising
maintaining a black-list database of unwanted network addresses, and
identifying unwanted senders by comparing a user characteristic to the black-list database.

12. The method of claim 1, the method further comprising:
providing the recipient with a local email inbox which receives only email drawn to the recipient's recipient identifier in said first database; wherein
said sending step sends the email to said local email inbox.

13. The method of claim 1, wherein
said sending step sends the email to the recipient's email address.

14. The method of claim 1, the method further comprising:
providing the user with an interface for composing the email; wherein
said taking step accepts the email by way of said interface.

15. The method of claim 1, wherein
said taking step accepts the email by way of another email application.

16. The method of claim 1, the method further comprising:
providing the user with an interface for searching said first database.

17. The method of claim 1, the method further comprising:
providing the user with an interface for browsing said first database.

18. An apparatus which provides an email from a user to a recipient, the apparatus comprising:
a first database of recipients including recipient identifiers and recipient email addresses;
a second database of user descriptors not directly entered by the user;
an email taker which takes an email from the user, wherein the email is directed to at least one recipient identifier;
an email sender which sends the email to the recipient and further sends at least one user descriptor to the recipient;
wherein no recipient email address is revealed to the user.

19. The apparatus of claim 18, wherein
at least one of said recipient identifiers is a categorical identifier applied to more than one recipient, and
the email is directed to at least one categorical identifier.

20. The apparatus of claim 19, wherein said categorical identifier includes only recipients who have agreed to be identified by categorical identifier.

21. The apparatus of claim 18, the apparatus further comprising:
a third database of email descriptors; and
an analyzer that computes at least one usage pattern from said third database;
wherein said email sender further sends said usage pattern to the recipient.

22. The apparatus of claim 18, the apparatus further comprising:
a third database of email descriptors; and
an analyzer that computes the likelihood based on said email descriptors that the email is a duplicate of a previously-sent email.

23. The apparatus of claim 18, the apparatus further comprising:
an automaton analyzer that computes the likelihood that the user is an automaton.

24. The apparatus of claim 18, the apparatus further comprising:
an analyzer that computes if the email contains objectionable content.

25. The apparatus of claim 18, the apparatus further comprising:
a local email inbox which receives only email drawn to the recipient's recipient identifier in said first database; wherein said sender sends the email to said local email inbox.

26. The apparatus of claim 18, wherein
said sender sends the email to a recipient's email address.

27. The apparatus of claim 18, the apparatus further comprising:
an interface for composing the email; wherein said taker accepts the email by way of said interface.

28. The apparatus of claim 18, wherein
said taker takes the email by way of another email application.

29. The apparatus of claim 18, the apparatus further comprising:
an interface for searching said first database.

30. The apparatus of claim 18, the apparatus further comprising:
an interface for browsing said first database.

31. The apparatus of claim 18, the apparatus further comprising:
a black-list database of unwanted network addresses, and
an analyzer that identifies unwanted senders by comparing a user characteristic to the black-list database.

32. A system for sending an email from a user to a recipient, the system comprising:
means for maintaining a first database of recipients including recipient identifiers and recipient email addresses, and including an entry for the recipient;
means for maintaining a second database of user descriptors not directly entered by the user;
means for taking the email from the user, wherein the email is directed to at least one of said recipient identifiers;
means for sending the email to the recipient; and
means for sending at least one of said user descriptors to the recipient;
wherein no recipient email address is revealed to the user.

33. A machine readable medium containing instructions for sending an email from a user to a recipient, the medium comprising:
instructions for maintaining a first database of recipients including recipient identifiers and recipient email addresses, and including an entry for the recipient;
instructions for maintaining a second database of user descriptors not directly entered by the user;
instructions for taking the email from the user, wherein the email is directed to at least one of said recipient identifiers;
instructions for sending the email to the recipient; and
instructions for sending at least one of said user descriptors to the recipient;
wherein no recipient email address is revealed to the user.
